(19) United States
(12) Patent Application Publication
(10) Pub. No.: US 2005/0043036 A1
(43) Pub. Date: Feb. 24, 2005

(54) Apparatus and method for obtaining location information of mobile stations in a wireless communications network

(76) Inventors: Igor V Ioppe, San Francisco,, CA (US); Tasso Roumeliotis, Berkeley, CA (US); Scott Allen Hotes, El Cerrito, CA (US); Priva Viswanath, Concord, CA (US)

Correspondence Address: Ralph A. Dowell of DOWELL & DOWELL P.C., 2111 Eisenhower Ave., Suite 406, Alexandria, VA, 22314, US

(21) Appl. No.: 10/482,655

(22) PCT Filed: Jul. 5, 2002
(86) PCT No.: PCT/CA02/01029

Related U.S. Application Data
(60) Provisional application No. 60/303,019, filed on Jul. 5, 2001.

(30) Foreign Application Priority Data
Jul. 16, 2001 (US) 60305580

(51) Int. Cl. H04Q 7/20

(52) U.S. Cl. 455/456.1

(57) ABSTRACT

A data processing device for use in a communications network capable of supporting users of mobile stations, as well as a method of processing data elements exchanged between a pair of entities in such a network. The invention relies on techniques for receiving and processing the content of data elements that are exchanged or generated in the course of ordinary network operation in order to derive information that can be used to ascertain the location of mobile stations in the network. The location information is provided to a location-based services (LBS) application. Thus, mobile station location information is obtained without the LBS application specifically requesting that such information be generated or exchanged, which potentially relieves the network of a considerable amount of congestion and resource scarcity.

### CROSS-REFERENCES TO RELATED APPLICATIONS

The present invention claims the benefit of U.S. Provisional Patent Application Ser. No. 60/303,019 to Viswanath et al., filed on Jul. 5, 2001 and hereby incorporated herein by reference.

### FIELD OF THE INVENTION

The present invention relates generally to communications networks and, more particularly, to obtaining position information about mobile stations in a wireless communication network.

### BACKGROUND OF THE INVENTION

In the current age of significant telecommunications competition, mobile network operators continuously seek new and innovative ways to create differentiation and increase profits. One of the best ways to accomplish this goal is through the delivery of highly personalized services, such as location-based services (LBS). Moreover, mobile network operators are required under the laws of certain national governments to equip their infrastructure with the ability to provide LBS, particularly having regard to emergency services. In all, there are at least four major categories of LBS, namely location-based information, location-sensitive billing, emergency services and tracking.

One of the most obvious and important aspects of LBS is positioning, i.e., the ability to determine the position of a mobile station in the network. One example of a widely recognized positioning technology is the Global Positioning System (GPS). In addition to GPS, other positioning techniques typically rely on various means of triangulation of the signal from cell sites serving a mobile station. In addition, the serving cell site can be used as a fix for location of the user.

Geographic data is another important aspect of any location system. Geographic Information Systems (GIS) provide the tools to provision and administer base map data such as man-made structures (streets, buildings) and terrain (mountains, rivers). GIS is also used to manage point-of-interest data such as location of gas stations, restaurants, nightclubs, etc. Finally, GIS information also includes information about the radio frequency characteristics of the mobile network. This allows the system to determine the serving cell site of the user.

Finally, it is not enough to be able to position the mobile user and know the map data around that position. There must also be provided a location management function to process positioning and GIS data on behalf of LBS applications. The location management function is middleware that acts as a gateway and mediator between positioning equipment and the LBS infrastructure. Among other things, the location management function may be employed to convert positioning information into useful location information and make it available for various LBS applications.

In conventional wireless intelligent networks, a request/answer mechanism involving the location management function and one or more of the base station controller (BSC), mobile switching center (MSC), home location register (HLR) and visited location register (VLR) is used to determine position information regarding a mobile station in the network. This is done by leveraging the SS7 signaling that is supported by both of today's prevailing wireless network protocols, namely American National Standards Institute (ANSI)-41 and Global System for Mobility (GSM).

For example, the Wireless Intelligent Network (WIN) standard—also known as IS-848 and based on the ANSI-41 protocol—provides for the position of a mobile station to be obtained in the following manner. The location management function at a given service control point interrogates an HLR using a specific position request (PosReq) message. The HLR knows the last VLR that served the mobile user. Accordingly, the HLR launches a request to this VLR for position information (such as a cell site identifier) and, upon receiving this information, sends it back to the service control point in a PosReq response message.

Similarly, the Customized Applications for Mobile Enhanced Logic (CAMEL) standard—based on the GSM protocol—provides for a location management function at a given service control point to launch a mobile application part (MAP) any time interrogation (ATI) message to the HLR for position information. The HLR responds with approximate information (such as the cell of origin) or more precise information achieved through use of a mobile network operation called timing advance or a procedure called network measurement report.

As can be appreciated, conventional techniques such as those just described require that the network be capable of specifically addressing each location request soon after it is generated. Moreover, in order for most LBS applications to be of any value, it will be necessary to request user location information at intervals of minutes or less. It is therefore apparent that the network will become increasingly, if not overly, congested as it attempts to satisfy frequent requests on behalf of each LBS application, for each user of interest. As a result, the switching and transport capacity of a wireless network will be eroded by the burdensome requirements of obtaining location information in a conventional manner.

Against this background, there is clearly a need to enable convenient and/or necessary LBS applications by obtaining valuable location information without the location management function having to query the network for such information on behalf of the LBS application.

### SUMMARY OF THE INVENTION

The present invention relies on the content of data elements that are exchanged or generated in the course of ordinary network operation in order to derive information that can be used to ascertain the location of mobile stations in the network. Thus, mobile station location information is obtained without specifically requesting that such information be generated or exchanged, which potentially relieves the network of a considerable amount of congestion and resource scarcity.

Accordingly, the present invention may be broadly summarized as a data processing device, including an input for receiving data elements exchanged between at least two entities in a communication network providing communication services to mobile stations, a processing unit for deriving location information about a plurality of the mobile stations from the data elements and an output for releasing the location information about the plurality of the mobile stations to a location-based services application, wherein the releasing of the location information about the plurality of the mobile stations is unrelated to the receipt of the data elements exchanged between the at least two entities from which the location information about the plurality of the mobile stations is derived.

By the release of the location information being “unrelated” to the receipt of the data elements exchanged between the at least two entities, it is meant that the data elements are received at a first set of time instants, while mobile station location information is released at a second set of time instants and there is no causal relationship between the two sets of time instants. Thus, for example, the mobile station location information may contain location information that has been derived very recently or it may contain “stale” location information that is about to be updated, unbeknownst to the device. Thus, mobile station location information is obtained without the location-based services application having to request that such information be generated or exchanged, which potentially relieves the network of a considerable amount of congestion and resource scarcity.

According to a second broad aspect, the present invention may be summarized as a method of collecting mobile station location information. The method includes receiving data elements exchanged between at least two entities in a communication network providing communication services to mobile stations, deriving location information about a plurality of the mobile stations from the data elements and releasing the location information about the plurality of the mobile stations to a location-based services application, wherein the releasing of the location information about the plurality of the mobile stations is unrelated to the occurrence of messages exchanged between the at least two entities from which the location information about the plurality of the mobile stations is derived.

According to a third broad aspect, the present invention may be summarized as computer-readable media tangibly embodying a program of instructions executable by a computer to perform the above method.

According to a fourth broad aspect, the present invention may be summarized as a computer readable storage medium containing a program element for execution by a computing device to implement the above method.

According to a fifth broad aspect, the present invention may be summarized as an apparatus for use in a communications network capable of supporting users of mobile stations. The apparatus includes an input for receiving data elements, at least some of the data elements being unrelated to requests for location information capable of being originated by a location-based services (LBS) application, a processing unit capable of deriving mobile station location information from the at least some of the data elements and an output capable of providing the mobile station location information to the LBS application.

Furthermore, the invention may be embodied in a processing platform programmed for implementing the above method.

Also, it should be understood that the term “processing” in the following is meant to encompass actions including but not limited to collecting, sorting, manipulating, transforming, filtering or storing, or any combination thereof.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

In the accompanying drawings:

FIG. 1 shows, in block diagram form, part of a cellular network infrastructure to which is connected a data processing device in accordance with an embodiment of the present invention;

FIG. 2 shows a diagram of a message flow that conveys location information which can be accessed by the data processing device of FIG. 1; and

FIG. 3 shows a technique for accessing records exchanged between a computer and a memory element, in accordance with an embodiment of the present invention.

### DETAILED DESCRIPTION OF THE PREFERRED EMBODIMENTS

The present invention recognizes that many data elements exchanged via interfaces and messages in a typical wireless network infrastructure already convey some high-level information about the location of mobile users, which can be gathered and supplied to an LBS application. For instance, entities within the network must have some idea of the location of the mobile station in order to be able to route incoming calls to the subscriber. They must also be aware of whether the mobile station is ON or OFF (known as presence information), so that they can handle incoming calls to that mobile station. In the remainder of the specification, the term “location” refers to either or both of the actual location of the mobile station and the presence of the mobile station.

The way in which the data elements exchanged by way of interfaces and messages are received by a device of the present invention varies from one embodiment to the next. At least three non-limiting cases are possible. In the first case, the data elements exchanged between two entities across an interface are passively monitored along that interface. In the second case, the data elements exchanged between the two entities across a first interface are duplicated and accessed along a different interface from the first interface. In the third case, the data elements exchanged between the two entities are intercepted at the interface between the two entities. Details regarding each of these cases will become apparent from a consideration of the following example embodiments of the present invention.

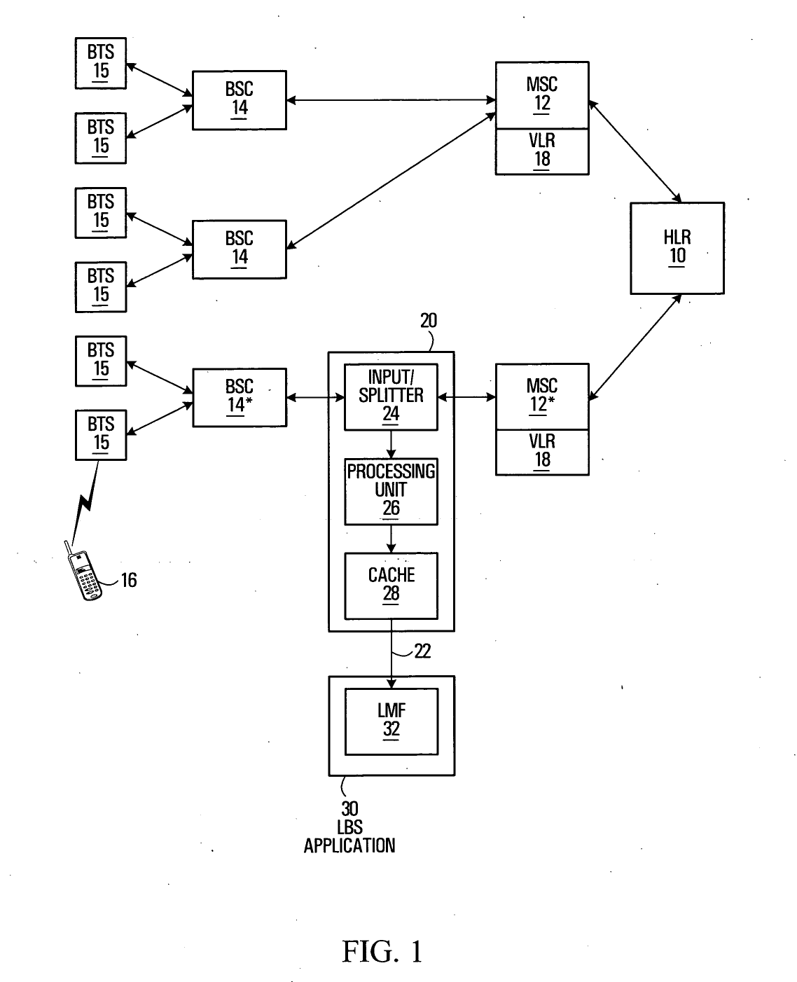

With reference to FIG. 1, there is shown part of a cellular network infrastructure including a data processing device 20 in accordance with an embodiment of the present invention. The cellular network infrastructure includes a home location register (HLR) 10 that interfaces with a plurality of mobile switching centers (MSCs) 12. The HLR 10 maintains permanent or slowly varying information about the mobile users in the network. Each of the MSCs 12 interfaces with at least one respective base station controller (BSC) 14, each of which communicates with a respective plurality of base station transceiver subsystems (BTSs) 15. Finally, each BTS 15 communicates in wireless fashion with mobile stations 16 located in a geographic area proximate the particular BTS 15. The area covered by each BTS 15 is usually a cell or a cell sector and thus a BSC 14 communicating with multiple BTSs 15 is associated with a plurality of cells or cell sectors and an MSC 12 communicating with multiple BSCs 14 is associated with an even greater number of cells or cell sectors.

Operationally, the HLR 10 communicates messages with the MSCs 12, while the MSCs 12 communicate messages with their respective BSCs 14. By way of non-limiting example, communication in an ANSI-41 or GSM network may be achieved using a variety of signaling protocols, including but not limited to SS7 and transmission control protocols based on the Internet Protocol. It should further be noted that the communication links between the various network entities 10, 12, 14 may consist of a wireless, wireline, fiber optic, free space optic, microwave or other medium having suitable operational characteristics.

Associated with each particular MSC 12 is a visited location register (VLR) 18, which maintains current information about those mobile stations which happen to find themselves in one of the cells associated with the particular MSC 12. As example of information related to a mobile station is the “location area” of the mobile station, defined as the cell global identity (in GSM) or service area identification (in ANSI-41) where the mobile station is in radio contact or was last in radio contact. The VLR 18 may be integrated within the MSC 12 or it may communicate with the MSC 12 through a separate interface.

The VLR 18 updates the location area (cell global identity or service area identification) of a mobile station 16 at the establishment of every radio connection with that mobile station 16. If the mobile station 16 remains within a given location area, the position of the mobile station within that location area will change but location area will not. Knowledge of the speed and direction of the mobile station may allow the instantaneous position of the mobile station within a location area to be estimated to a certain degree of certainty. As the mobile station roams, however, the cell global identity or service area identification may change, prompting a location area update procedure.

In accordance with a specific embodiment of the present invention, the data processing device 20 is provided at the MSC-BSC interface of a particular MSC 12* and a particular BSC 14*. The device includes an input 24 for acquiring data elements, in this case messages, exchanged between the participating MSC 12* and BSC 14*. The occurrence of messages at the MSC-BSC interface may follow a random, periodic or sporadic pattern. The device 20 has an output 22 which releases mobile station location information to an LBS application 30, possibly via a location management function (LMF) 32. According to the invention, the release of the mobile station location information by the device 20 is unrelated to the occurrence of the messages exchanged between the MSC 12* and the BSC 14*.

It should be understood that the device 20 may be placed at another interface either instead of, or in conjunction with, the MSC-BSC interface. For example, it is within the scope of the present invention to monitor the messages traveling the HLR-MSC interface for the presence of location information. Also, if the MSC 12 is separate from the VLR 18 such that the MSC-VLR interface is defined and accessible, then device 20 can be connected at this MSC-VLR interface. Moreover, it is possible that monitoring more than one interface will increase the amount, precision and/or accuracy of the location information pertaining to a particular user. However, for the purpose of understanding the present invention, it is sufficient to consider that the device 20 is positioned at the MSC-BSC interface.

The input 24 may be embodied in various ways, such as a passive signal splitter in the form of a wye-coupler which would be connected to the link between the MSC 12* and BSC 14*, an electro-inductive coupler that would be coupled in non-contact fashion to the link joining the MSC 12* and the BSC 14*, a repeater with branch-off or processing capability or any other suitable signal splitting device. In the case where the signal is intercepted, a copy made and the original re-transmitted along the link, a slight delay may be introduced on the link joining the MSC 12* and the BSC 14*. However, since it is possible to re-transmit the received message within microseconds, the effects of making a copy will be negligible.

The device 20 also includes a processing unit 26 capable of deriving mobile station location information from the data elements in the exchanged messages. To this end, the processing unit 26 may include a computer-readable medium that stores instructions for causing the processing unit 26 to execute a filtering operation in accordance with a set of rules. Specifically, the processing unit 26 first determines a characteristic of the message currently passing along the MSC-BSC interface and then assesses whether this message is to be retained on the basis of its characteristic.

In one example, the characteristic is whether the message conveys at least partial location information about the user's mobile station. If so, the message is registered (or retained, in the case of a duplicated message), otherwise the message is ignored (or discarded, in the case of a duplicated message). Since messages are typically standardized, it is possible to program the processing unit 26 to retain only certain types of messages that are known a priori to convey location information. For instance, messages containing location area updates as issued during periodic or spontaneous registration of a mobile station will fall into this category.

In an alternate example, the characteristic is not only whether the message conveys location information about the user's mobile station, but also whether the user falls within a specific subset of users. Thus, as a first step, the processing unit 26 could be programmed to ignore (or discard) those messages that are not associated with the ID of certain mobile stations prior to making any determination as to whether the message conveys mobile station location information.

The mobile station location information which has been accepted (i.e., registered or passed through) by the processing unit 26 can then be provided directly to the location management function (LMF) 32 of the LBS application 30, although it may be advantageous to first provide the mobile station location information to a location cache 28 within the device 20. The location cache 28 is a read-writable memory that keeps a record of mobile station location information retrieved from the messages exchanged between the BSC 14* and the MSC 12*. Such information could include mobile station ID, location area of the mobile station, and the source of the information. The location cache 28 could either store the information over time or it could be designed to replace stale location information about the mobile stations with fresh location information about the mobile stations.

The information in the location cache 28 is released via the output 22 of the device 20 to the LBS application 30, more specifically to the location management function 32 of the LBS application 30. The location management function 32 integrates the location information received from the device 20 with geographic data to generate useful location information and make it available for the LBS application 30. Those skilled in the art should appreciate that once the LBS application 30 obtains the mobile station location information from the data processing device 20, it can then provide a variety of location-based services to the mobile station according to any one of a number of standards, including but not limited to AIN, WIN, INAP and CAMEL, and using any suitable data delivery technology, such as WAP, SMS, MMS and iMode, for example.

It is noted that neither the device 20 nor the LBS application 30 need to query the MSC 12* or the BSC 14* or any other network entity in order to obtain location information about the mobile station. Rather, the data elements are received by the data processing device 20 at a first set of time instants, while mobile station location information is released to the location management function 32 at a second set of time instants and there is no causal relationship between the two sets of time instants. Thus, for example, the mobile station location information may contain location information that has been derived very recently or it may contain “stale” location information that is about to be updated, unbeknownst to the device 20. In general, it can be said that the release of the mobile station location information by the device 20 is unrelated to the occurrence of the messages exchanged between the MSC 12* and the BSC 14*.

By monitoring the data elements crossing the MSC-BSC interface (in this example) and retaining only those data elements that are related to mobile station location information, the present invention allows valuable location information to be obtained without expending any additional transport or switching resources. Other parts of the wireless infrastructure may be monitored for other bookkeeping events that allow cell-site or cell-sector information to be accessed in near-real time, which can be used as a satisfactory substitute to more resource-intensive techniques for determining mobile station location information.

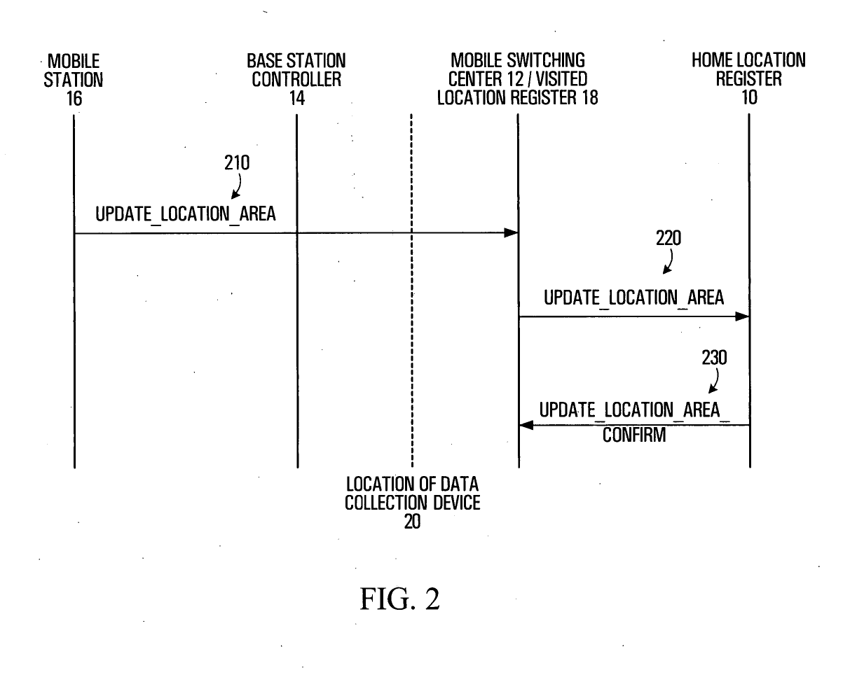

With reference to FIG. 2, there is provided an example of a possible message sequence that may occur in an existing GSM cellular network when a mobile station 16 enters a new location area. At step 210, the mobile station 16 initiates a location update process by sending an UPDATE_{—}LOCATION_{—}AREA message to the MSC 12 after establishing a radio access channel with the BSC 14 in its current location area. If the previous and current location areas are handled by the same MSC 12, only the associated VLR 18 needs to be updated. However, if the two location areas are handled by different MSCs, then the HLR 10 must be updated. Under such circumstances, the MSC 12 may invoke an UPDATE_{—}LOCATION_{—}AREA service at step 220 to update the HLR 10 about the new location of the mobile station 16. At step 230, the HLR sends an UPDATE_{—}LOCATION_{—}AREA confirmation to the MSC 12 associated with the VLR 18 where the mobile station 16 is currently registered, thus terminating the registration process.

From the foregoing, it is apparent that location information passes through the MSC-BSC interface at step 210, at which point the current location area of the mobile station 16 becomes available to the data processing device 20 without ever having been requested by the device 20 or the LBS application 30. Additionally, if the device 20 were installed at the MSC-HLR interface, location information about the mobile station 16 in question would have been accessible at steps 220 and 230, in the event that the mobile station has migrated to a new location area.

In another example, when the mobile station 16 is switched OFF or ON, IMSI (International Mobile Subscriber Identity) detach or attach procedures are executed, respectively. These procedures are similar to the location update procedure described above. However, the detached status of the mobile station 16 is only stored locally in the VLR 18. If the IMSI attach is in the same location area as the previous IMSI detach, then the HLR 10 is not informed of the attach. If, however, they are in different location areas (as when a mobile station is switched off and moved to another location and then switched on), the HLR 10 would have to be informed just as in the case of a location update. In this scenario, a data element indicative of the detached status of the mobile station reaches the VLR 18, which means that the device 20 installed at the BSC-MSC interface would be privy to this information. The processing unit 26 of the device 20 conveys this information to the location cache 28 or to the location management function 32. Since the mobile station 16 is now detached, the location management function 32 may need to apply a probabilistic model in determining the actual location area of the mobile station 16.

In this example, location information about the mobile station 16 is again obtained without having to generate a request for such information. This allows processing resources in the HLR 10, MSC 12 and BSC 14 to be spared. Moreover, information residing in the VLR 18 is picked up as it is sent by the MSC 12 to the HLR 10 or to the BSC 14, transforming the data elements in the VLR into useful location information regarding the mobile station 16.

Although the previous specific example from the field of cellular systems has been used for purposes of illustrating the invention, it should be understood that it is within the scope of the present invention to acquire and process information exchanged in other types of wireless network infrastructures, be they for voice or data communications. For example, it should be mentioned that in a General Packet Radio Service (GPRS) network, a serving GPRS support node (SGSN) is connected between the HLR and the VLR. In the case of such a network, the device 20 could be placed at the interface between the VLR and the SGSN or the interface between the SGSN and the HLR. It should therefore be apparent that the present invention is not limited to any particular implementation and may be used with cellular, GPRS and other types of networks.

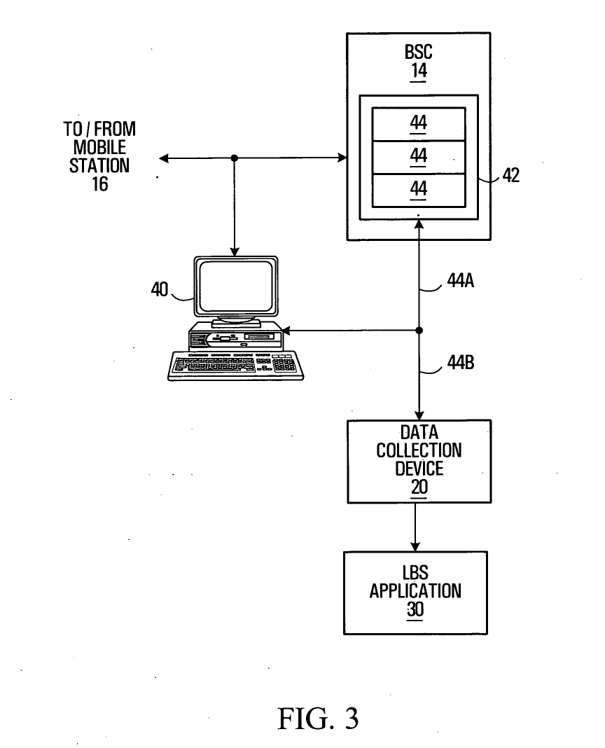

In an alternative embodiment of the present invention, the device 20 is used to monitor billing records to determine mobile station location information. With reference to FIG. 3, the BSC 14 contains billing records 44 which store information regarding various actions between the BSC 14 and the mobile stations 16 (such as registration updates) in the geographic region serviced by the BSC 14. The billing records 44 are generated by a computer 40 which monitors the interface between the BSC 14 and the mobile stations 16. The computer 40 is adapted to store the billing records in a memory 42 at the BSC 14 (as shown) or elsewhere in the network.

The billing records 44 can be monitored by the device 20 of the present invention in several ways. In one example, as illustrated, the computer 40 generates duplicate billing records 44A, 44B, one copy 44A of which is sent to the memory 42 and the other copy 44B of which is sent to the device 20 for eventual use by the LBS application 30. In another example, the interface on which the billing records 44 are delivered to the memory 42 can be monitored in much the same way as the MSC-BSC interface was monitored in the scenario of FIG. 1.

It should be appreciated that the computer 40 which generates billing records 44 for the BSC 14 does not necessarily sit at the interface between the mobile station 16 and the BSC 14. In some scenarios, for example, the computer 40 could be entirely within the BSC 14 or, in other scenarios, the computer 40 and the memory 42 both lie within the MSC 12. In either case, the device 20 has the capability to acquire the data elements exchanged between the computer 40 and the memory 42, either by virtue of a link to the computer 40 and by having a link to the memory 42. It should be noted that since the format of the billing records 44 is proprietary, the data processing device 20 will need to be engineered to be compatible with the specific billing record format used by the MSC or BSC vendor.

In another alternative embodiment of the present invention, the device 20 is used to monitor data elements exchanged between a BSC 14 and a BTS 15 in order to maintain communication between the BTS 15 and a particular mobile station 16. Most frequently, the data elements of interest will carry information related to measurements made across the air interface between the mobile station 16 and the BTS 15. Such measurements can include the strength of the signal between the mobile station 16 and the BTS 15 (e.g., pilot strength measurement in code division multiple access—CDMA) or signal propagation time (e.g., timing advance measurement in GSM). This information can be used to estimate user position for location-based services.

For example, a pilot signal strength measurement may give the strength of all pilot signals on an active list of BSCs stored in the memory of a mobile station. This could be used with a triangulation method to obtain an approximate user location. For its part, the timing advance gives the propagation time, within a single cell, of the mobile station 16 to the BTS 15. This can narrow down the possible location of the mobile station 16 from an entire region to an arc-like area within the cell. Either type of information could also be duplicated within the BSC 14 and provided on a separate interface (rather than having the device 20 listen—or tap into—the BSC-MSC interface).

In still another alternative embodiment of the present invention, the device 20 may be used in an IP network that includes a plurality of gateways. In the case of a mobile IP network, each gateway is associated with a network address (an IP address) and communicates with mobile stations in its geographic vicinity. Various ones of the gateways are “home gateways” for respective sets of mobile stations. In order to send data to a mobile station in the mobile IP network, it is necessary for the home gateway to know the IP address of the gateway in whose vicinity the mobile station is currently active. This IP address is known as the “care of” address for that mobile station. When a mobile device registers on a remote network, the care-of-address is delivered back to the home gateway. Most care-of-addresses can be logically mapped to the geographic gateway on which the user is active.

In the case of a wired or wireless local area network (LAN), connections are made through gateways via wired or wireless internet service providers (ISPs). These gateways can provide information regarding the geographic location from which the connection was made. For example, when connecting to a wireless LAN in a coffee shop, location-based services can use the IP address of the router and map that to the location of the coffee shop from which the user is connecting.

In either of the two preceding examples, it may be advantageous to place the device 20 such that it monitors part of the path between two gateways in the respective IP network. Since an IP network is based on a store-and-forward architecture, a low-impact technique for receiving information exchanged between two entities, in this case gateways, would be to intercept the flow of datagrams (packets) on the path between the two gateways and either duplicate the data elements traveling on this path or process them with the processing unit 26 prior to regenerating each incoming packet.

Those skilled in the art should appreciate that the processing unit 26 of the data processing device 20 may be implemented as an arithmetic and logic unit (ALU) having access to a code memory (not shown) which stores program instructions for the operation of the ALU. The program instructions could be stored on a medium which is fixed, tangible and readable directly by the processor, (e.g., removable diskette, CD-ROM, ROM, or fixed disk), or the program instructions could be stored remotely but transmittable to the processor via a modem or other interface device (e.g., a communications adapter) connected to a network over a transmission medium. The transmission medium may be either a tangible medium (e.g., optical or analog communications lines) or a medium implemented using wireless techniques (e.g., microwave, infrared or other transmission schemes).

Those skilled in the art should also appreciate that the program instructions stored in the code memory can be compiled from a high level program written in a number of programming languages for use with many computer architectures or operating systems.

For example, the high level program may be written in assembly language, while other versions may be written in a procedural programming language (e.g., “C”) or an object oriented programming language (e.g., “C++” or “JAVA”).

Those skilled in the art should further appreciate that in some embodiments of the invention, the functionality of the processing unit 26 may be implemented as pre-programmed hardware or firmware elements (e.g., application specific integrated circuits (ASICs), electrically erasable programmable read-only memories (EEPROMs), etc.), or other related components.

While specific embodiments of the present invention have been described and illustrated, it will be apparent to those skilled in the art that numerous modifications and variations can be made without departing from the scope of the invention as defined in the appended claims.

1. A data processing device, comprising:
an input for receiving data elements exchanged between at least two entities in a communication network providing communication services to mobile stations;
a processing unit for deriving location information about a plurality of the mobile stations from the data elements;
an output for releasing the location information about the plurality of the mobile stations to a location-based services application;
wherein the releasing of the location information about the plurality of the mobile stations is unrelated to the receipt of the data elements exchanged between the at least two entities from which the location information about the plurality of the mobile stations is derived.

2. A data processing device as defined in claim 1, wherein the at least two entities communicate via an interface, said input being adapted to passively monitor the interface.

3. A data processing device as defined in claim 2, said input including a passive signal splitter.

4. A data processing device as defined in claim 2, said input including a non-contact electro-inductive coupler.

5. A data processing device as defined in claim 1, wherein the at least two entities communicate via a first interface, said input being adapted to receive copies of the data elements along a second interface different from the first interface.

6. A data processing device as defined in claim 1, said input including a module capable of intercepting the data elements destined for at least one of the at least two entities and providing the intercepted data elements to the processing unit.

7. A data processing device as defined in claim 6, said module being further capable of re-transmitting the intercepted data elements towards the at least one of the at least two entities.

8. A data processing device as defined in claim 6, wherein any delay introduced by said module in intercepting the data elements is negligible.

9. A data processing device as defined in claim 1, wherein the receipt of the data elements is sporadic.

10. A data processing device as defined in claim 9, wherein the releasing of location information occurs periodically.

11. A data processing device as defined in claim 1, wherein deriving location information about the plurality of the mobile stations from the data elements includes:
determining whether a received data element conveys location information about a mobile station; and
if the received data element conveys location information about a mobile station, extracting the location information about the mobile station from the received data element.

12. A data processing device as defined in claim 11, wherein determining whether a received data element conveys location information about a mobile station includes determining a data element type associated with the received data element and comparing the data element type to a set of data element types known to convey location information about a mobile station.

13. A data processing device as defined in claim 1, wherein deriving location information about the plurality of the mobile stations from the data elements includes:
determining whether a received data element conveys information regarding a mobile station belonging to a predetermined set of mobile stations;
if the received data element conveys information regarding a mobile station belonging to a predetermined set of mobile stations, determining whether the received data element conveys location information about the mobile station belonging to the predetermined set of mobile stations and if so, extracting the location information about the mobile station belonging to the predetermined set of mobile stations from the received data element.

14. A data processing device as defined in claim 1, wherein the location information about the plurality of mobile stations includes information regarding a geographic location of each mobile station.

15. A data processing device as defined in claim 1, wherein the location information about the plurality of mobile stations includes information regarding a presence of each mobile station.

16. A data processing device as defined in claim 1, further comprising a location cache for storing the location information about the plurality of mobile stations derived by the processing unit.

17. A data processing device as defined in claim 16, said location cache being capable of storing at least two sets of location information about the plurality of mobile stations derived by the processing unit at different instants in time.

18. A data processing device as defined in claim 16, said location cache being capable of replacing stale location information about the plurality of mobile stations with fresh location information about the plurality of mobile stations.

19. A data processing device as defined in claim 1, wherein the data elements include messages exchanged between the at least two entities.

20. A data processing device as defined in claim 19, wherein the messages include messages other than requests for location information originated by the location-based services application, said processing unit being adapted to derive the location information about the plurality of mobile stations from the messages other than requests for location information originated by the location-based services application.

21. A data processing device as defined in claim 19, wherein the messages are in accordance with the ANSI-41 protocol.

22. A data processing device as defined in claim 19, wherein the messages are in accordance with the GSM protocol.

23. A data processing device as defined in claim 1, wherein the data elements include billing records.

24. A data processing device as defined in claim 23, wherein the at least two entities include a computer and a memory.

25. A data processing device as defined in claim 1, wherein the data elements include messages indicative of a measured strength of a wireless signal.

26. A data processing device as defined in claim 25, wherein the wireless signal is a pilot signal.

27. A data processing device as defined in claim 25, said processing unit being adapted to derive the location information about the plurality of mobile stations by estimating a mobile station location from the measured strength of the wireless signal.

28. A data processing device as defined in claim 1, wherein the data elements include messages indicative of a measured propagation time of a wireless signal.

29. A data processing device as defined in claim 28, said processing unit being adapted to derive the location information about the plurality of mobile stations by estimating a mobile station location from the measured propagation time of the wireless signal.

30. A data processing device as defined in claim 1, wherein data elements include datagrams indicative of a network address of a router.

31. A data processing device as defined in claim 30, said processing unit being adapted to derive the location information about the mobile units by mapping the network address of the router to a geographic location.

32. A data processing device as defined in claim 30, wherein the network is a mobile IP network and wherein the network address of the router is a care-of address.

33. A data processing device as defined in claim 30, wherein the network is a fixed IP network and wherein the network address of the router is the IP address of an IP gateway.

34. A method of collecting mobile station location information, comprising:
receiving data elements exchanged between at least two entities in a communication network providing communication services to mobile stations;
deriving location information about a plurality of the mobile stations from the data elements;
releasing the location information about the plurality of the mobile stations to a location-based services application;
wherein the releasing of the location information about the plurality of the mobile stations is unrelated to the receipt of the data elements exchanged between the at least two entities from which the location information about the plurality of the mobile stations is derived.

35. A method as defined in claim 34, wherein the at least two entities communicate via an interface and wherein receiving data elements exchanged between the at least two entities includes intercepting the data elements at the interface.

36. A method as defined in claim 35, wherein receiving data elements exchanged between the at least two entities further includes generating a copy of the intercepted data elements.

37. A method as defined in claim 34, wherein deriving location information about the plurality of the mobile stations from the data elements includes:
determining whether a received data element conveys location information about a mobile station; and
if the received data element conveys location information about a mobile station, extracting the location information about the mobile station from the received data element.

38. A method as defined in claim 37, wherein determining whether a received data element conveys location information about a mobile station includes determining a data element type associated with the received data element and comparing the data element type to a set of data element types known to convey location information about a mobile station.

39. A method as defined in claim 34, wherein deriving location information about the plurality of the mobile stations from the data elements includes:
determining whether a received data element conveys information regarding a mobile station belonging to a predetermined set of mobile stations;
if the received data element conveys information regarding a mobile station belonging to a predetermined set of mobile stations, determining whether the received data element conveys location information about the mobile station belonging to the predetermined set of mobile stations and if so, extracting the location information about the mobile station belonging to the predetermined set of mobile stations from the received data element.

40. A system for collecting mobile station location information, comprising:
means for receiving data elements exchanged between at least two entities in a communication network providing communication services to mobile stations;
means for deriving location information about a plurality of the mobile stations from the data elements;
means for releasing the location information about the plurality of the mobile stations to a location-based services application;
wherein the releasing of the location information about the plurality of the mobile stations is unrelated to the receipt of the data elements exchanged between the at least two entities from which the location information about the plurality of the mobile stations is derived.

41. Computer-readable media tangibly embodying a program of instructions executable by a computer to perform a method of collecting mobile station location information, the method comprising:
receiving data elements exchanged between at least two entities in a communication network providing communication services to mobile stations;
deriving location information about a plurality of the mobile stations from the data elements;
releasing the location information about the plurality of the mobile stations to a location-based services application;
wherein the releasing of the location information about the plurality of the mobile stations is unrelated to the receipt of the data elements exchanged between the at least two entities from which the location information about the plurality of the mobile stations is derived.

42. A computer readable storage medium containing a program element for execution by a computing device to implement a method of processing data elements exchanged between a pair of entities in a communication network capable of supporting users of mobile stations, the program element including:
program code means for receiving data elements exchanged between at least two entities in a communication network providing communication services to mobile stations;
program code means for deriving location information about a plurality of the mobile stations from the data elements;
program code means for releasing the location information about the plurality of the mobile stations to a location-based services application;
wherein the releasing of the location information about the plurality of the mobile stations is unrelated to the receipt of the data elements exchanged between the at least two entities from which the location information about the plurality of the mobile stations is derived.

43. Apparatus for use in a communications network capable of supporting users of mobile stations, said apparatus comprising:
an input for receiving data elements, at least some of the data elements being unrelated to requests for location information capable of being originated by a location-based services (LBS) application;
a processing unit capable of deriving mobile station location information from the at least some of the data elements; and
an output capable of providing the mobile station location information to the LBS application.
